(19) United States
(12) Patent Application Publication
(10) Pub. No.: US 2008/0042599 A1
(43) Pub. Date: Feb. 21, 2008

(54) RIPPLE COMPENSATION METHOD AND APPARATUS

(75) Inventor: IAN ASHDOWN, West Vancouver (CA)

Correspondence Address: MCCORMICK, PAULDING & HUBER LLP, CITY PLACE II, 185 ASYLUM STREET, HARTFORD, CT, 06103, US

(73) Assignee: TIR TECHNOLOGY LP, Burnaby (CA)

(21) Appl. No.: 11/840,268

(22) Filed: Aug. 17, 2007

Related U.S. Application Data
(60) Provisional application No. 60/839,063, filed on Aug. 21, 2006.

(51) Int. Cl. G05F 1/10; H05B 41/36

(52) U.S. Cl. 315/294

(57) ABSTRACT

The present invention provides a ripple compensation method and apparatus that provides a means to compensate for drive current ripple-induced brightness fluctuations in an LEE based illumination system. The ripple compensation apparatus comprises a ripple evaluation module which is configured to evaluate a ripple compensation factor based on an evaluated fluctuation of the drive current. The evaluation of the fluctuation of the drive current can be determined based on information collected during operation of the LEE based illumination system and/or based on predetermined operational characteristics of the LEE based illumination. A control system comprises the ripple evaluation module and is operatively coupled to the one or more light-emitting elements, wherein the control system is configured to determine and provide control signals for operation of the one or more light-emitting elements based on the ripple compensation factor.

### CROSS REFERENCE TO RELATED APPLICATIONS

This application claims the benefit of U.S. Provisional Application Ser. No. 60/839,063, filed on Aug. 21, 2006, herein incorporated by reference in its entirety.

### FIELD OF THE INVENTION

The present invention pertains to illumination systems and in particular it pertains to drive current ripple compensation for LED type illumination systems.

### BACKGROUND OF THE INVENTION

Inorganic and organic semiconductor light-emitting diodes (LEDs) have been successfully used in illumination applications, including architectural, entertainment, and roadway lighting, for example. Light-emitting diode based luminaries often require specific forms of electrical power and cannot be operated directly with the forms of electricity which are provided by power grids. The amount of light emitted by LEDs depends on the LED drive current. The brightness of LEDs follows changes in the drive current in a transient fashion with delay times of typically 10⁻⁷ seconds or less. In contrast, the thermal capacities of filaments in incandescent light sources have four to five orders of magnitude slower transient dynamics. Hence LED luminaries require compensation of undesired effects of drive current fluctuations. This excludes the use of certain types of power converters which, while possibly simple and cost effective, are prone to cause undesired drive current fluctuations. Modular high quality power converters with, for example, drive current feedback control can significantly reduce LED flicker but generally are not able to take advantage of the unique characteristics of LEDs, are usually expensive and do not significantly improve the overall energy efficiency of the lighting system.

Therefore there is a need for a new ripple compensation method and apparatus which can overcome some of the disadvantages mentioned above and/or at least provide the public with a useful choice.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a ripple compensation method and apparatus. In accordance with an aspect of the present invention, there is provided an apparatus for compensating for ripple in a converter current supplied by a power converter for driving one or more light-emitting elements, the apparatus comprising: a ripple evaluation module configured to obtain an input indicative of the ripple present in the converter current and evaluate a ripple compensation factor based on said input; and a controller operatively coupled to said ripple evaluation module and configured to apply said ripple compensation factor to the converter current and thereby provide a drive current for driving the one or more light-emitting elements having reduced ripple.

In accordance with another aspect of the invention, there is provided a light source comprising: one or more light-emitting elements; a power converter for driving said one or more light-emitting elements; a ripple evaluation module configured to obtain an input indicative of the ripple present in a converter current supplied by said power converter, and evaluate a ripple compensation factor based on said input; and a controller operatively coupled to said ripple evaluation module and configured to apply said ripple compensation factor to said converter current and thereby provide a drive current for driving said one or more light-emitting elements having reduced ripple.

In accordance with another aspect of the invention, there is provided a method for compensating for ripple in a converter current supplied by a power converter for driving one or more light-emitting elements, the method comprising the steps of: obtaining an input indicative of the ripple present in the converter current; evaluating a ripple compensation factor based on said input; and applying said ripple compensation factor to the converter current and thereby providing a drive current for driving the one or more light-emitting elements having reduced ripple.

### BRIEF DESCRIPTION OF THE FIGURES

FIG. 1 illustrates an illumination system including a ripple compensation apparatus according to the present invention and showing various options for different embodiments.

FIG. 2 illustrates example variations in current I_{P} provided by a power converter over time due to ripple.

FIG. 3 illustrates drive current I_{D} provided to light-emitting elements by an LEE driver, the drive current being controlled by a ripple compensation apparatus according to one embodiment of the present invention.

FIG. 4 illustrates a flow chart for ripple compensation using a feedback configuration according to one embodiment of the present invention.

FIG. 5 illustrates a flow chart for ripple compensation using a feed-forward configuration according to one embodiment of the present invention.

### DETAILED DESCRIPTION OF THE INVENTION

### Definitions

The term “ripple” is used to define a form of residual harmonic content of a DC voltage or DC current signal at the output of a power converter.

The term “light-emitting element” (LEE) is used to define a device that emits radiation in a region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The term “control system” is used to define a computing device or microcontroller having a central processing unit (CPU) and, optionally, peripheral input/output devices (such as A/D or D/A converters) to monitor parameters from peripheral devices that are operatively coupled to the control system. These input/output devices can also permit the CPU to communicate and control peripheral devices that are operatively coupled to the control system. The control system can optionally include one or more storage media collectively referred to herein as “memory”. The memory can be volatile and non-volatile computer memory such as RAM, PROM, EPROM, and EEPROM, floppy disks, compact disks, optical disks, magnetic tape, or the like, wherein control programs (such as software, microcode or firmware) for monitoring or controlling the devices coupled to the control system are stored and executed by the CPU. Optionally, the control system also provides a means of converting user-specified operating conditions into control signals to control the peripheral devices coupled to the control system. The control system can receive user-specified commands by way of a user interface, for example, a keyboard, a touchpad, a touch screen, a console, a visual or acoustic input device as is well known to those skilled in this art.

As used herein, the term “about” refers to a +1-10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

A nominally constant output signal of a power converter comprises a DC signal, superimposed ripple and noise. A typically significant harmonic component of ripple usually occurs at twice the frequency of the AC voltage which is used to supply electric power to the power converter. Power converters can be supplied with electricity from a power grid with, for example, nominally 110/120V at 60 Hz in North America or 220/240V at 50 Hz in Europe. A distinction between ripple and noise signals can be made by considering the type of LEE control. For practical purposes relevant to lighting systems, noise can be considered to be the part of the drive current signal that causes brightness fluctuations which are practically not noticeable by a human observer. It may therefore be considered that noise causes practically insignificant brightness fluctuations.

Important characteristics of drive current ripple include amplitude, frequency and phase shift. These characteristics are largely determined by the type of power converter and the operating conditions in conjunction with the attached LEE circuitry. In addition, the phase shift refers to the temporal relation of harmonics in the output signal and the AC input signal of the power converter.

Generally, light-emitting elements can be controlled to emit light of a desired luminous flux output in a number of different ways such as by controlling the drive current amplitude (for example, via analog control) or by controlling the characteristics of a train of drive current pulses. For example, the duty factors in a pulse width modulated (PWM) drive current signal or the pulse density in a pulse code modulated (PCM) drive current signal can be altered to achieve this desired luminous flux output. PWM, PCM and analog control of LEE based luminaries is well known in the art.

The present invention provides a ripple compensation method and apparatus that enables the compensation of drive current ripple-induced brightness fluctuations in an LEE based illumination system. The ripple compensation apparatus comprises a ripple evaluation module which is configured to evaluate a ripple compensation factor based on an evaluated fluctuation of the drive current substantially due to ripple. The evaluation of the fluctuation of the drive current can be determined based on information sensed during operation of the LEE based illumination system and/or based on predetermined operational characteristics of the LEE based illumination and power source therefore. A control system comprises the ripple evaluation module and is further operatively coupled to the one or more light-emitting elements, wherein the control system is configured to determine and provide control signals for operation of the one or more light-emitting elements based on the ripple compensation factor.

In one embodiment, the control system is configured to determine and provide control signals for operation of the one or more light-emitting elements based on the ripple compensation factor and a desired time averaged drive current level that defines a desired lighting condition.

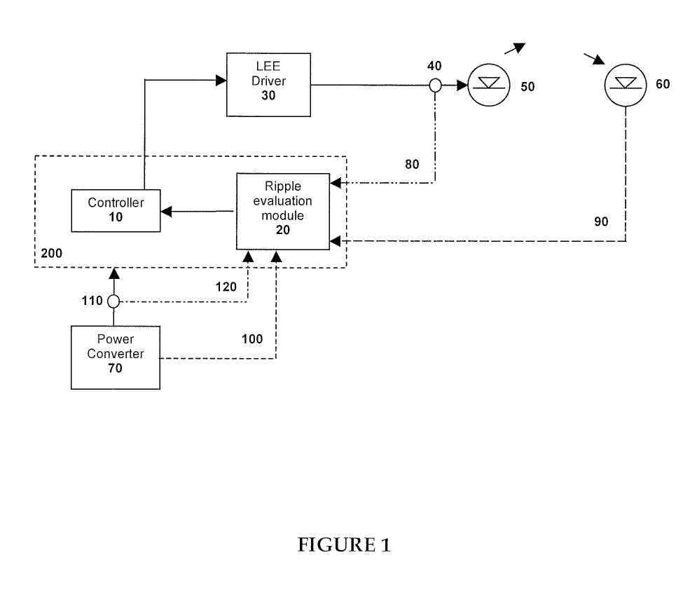

An illumination system including a ripple compensation apparatus according to one embodiment of the present invention is illustrated in FIG. 1. The illumination system comprises a control system 200, a LEE driver 30 which provides the drive current to the one or more light-emitting elements 50, thereby causing the LEE to emit light. The control system 200 includes a controller 10 and a ripple evaluation module 20, wherein the ripple evaluation module 20 is configured to determine a ripple compensation factor based on input indicative of the ripple present in the converter current.

In embodiments of the present invention, the ripple evaluation module can be operatively coupled to one or more components wherein these components can be the power converter, one or more of the light-emitting elements and/or an optical sensor. The operative connection between the ripple evaluation module and the one or more components can provide input for the determination of the ripple present in the converter current.

### Ripple Evaluation Module

In one embodiment, the ripple evaluation module is operatively coupled to the power converter and based on the predetermined operational characteristics of the power converter is configured to determine a ripple compensation factor. The ripple evaluation module can be preconfigured with information relating to operational characteristics of one or more different power converters, wherein this information can be configured as a look-up table or algorithm. Therefore, upon receipt of the power converter data 100 by the ripple evaluation module, the ripple evaluation module can evaluate a ripple compensation factor based on an evaluated drive current ripple.

As would be known to a worker skilled in the art, the information relating to the operational characteristics of a power converter can be configured in one or more data tables or calculated based on predetermined algorithms or other means. This information can be configured in firmware, hardware or software, as would be readily understood by a worker skilled in the art.

In an embodiment of the present invention, and as illustrated in FIG. 1, the ripple evaluation module is operatively coupled to a drive current sensing mechanism 40, which can provide drive current signals 80 representative of the drive current being supplied to the one or more light-emitting elements. The ripple evaluation module, based on the drive current signal input can be configured to evaluate a ripple compensation factor based thereon. The drive current sensing mechanism, such as a current sensor, can be a fixed resistor, a variable resistor, an inductor, a Hall effect current sensor, or other element which has a known voltage-current relationship and can provide a measurement of the current flowing through the one or more light-emitting elements, based on a measured voltage signal, as would be known to a skilled worker.

In an embodiment, and also as illustrated in FIG. 1, the ripple evaluation module 20 is configured to determine a ripple compensation factor based on determined ripple within the converter current being supplied by the power converter 70. In this embodiment the ripple evaluation module is operatively coupled to a drive current sensing mechanism 110, which is operatively coupled to an operational link between the power converter 70 and the control system 200 to provide drive current signals 120 representative of the drive current being supplied by the power converter to the control system. A current sensing mechanism can be can a fixed resistor, a variable resistor, an inductor, a Hall effect current sensor, or other element which has a known voltage-current relationship and can provide a measurement of the current flowing through the one or more Light emitting elements, based on a measured voltage signal, as would be known to a skilled worker.

In an embodiment of the present invention, and also as illustrated in FIG. 1, the ripple evaluation module is operatively coupled to an optical sensor 60, which provides optical signals 90 representative of the light output of the one or more light-emitting elements. The ripple evaluation module can be configured to evaluate a ripple compensation factor based on the detected light output of the one or more light-emitting elements.

In one embodiment, the optical sensor generates a signal representative of the average spectral radiant flux from the one or more light-emitting elements. In another embodiment the optical sensor generates a signal representative of the spectral radiant flux from one or more of the one or more light-emitting elements. The optical sensor can be a photodiode, an inactivate light-emitting element, photosensor or other optical sensor which is responsive to spectral radiant flux emitted by the one more light-emitting elements as would be known to a worker skilled in the art.

In an embodiment of the present invention, the ripple evaluation module is configured to evaluate a ripple compensation factor based on information which is based on two or more of the operational characteristics of the power converter, the one or more detected drive current signals, the detected converter current signal, and the one or more detected optical signals.

In one embodiment of the present invention, the ripple evaluation module comprises a dedicated computing device, for example a microprocessor or central processing unit, which is configured to determine a ripple compensation factor based on input information indicative of the ripple present in the converter current.

### Ripple Compensation

Ripple compensation can be implemented in a number of different ways in combination with pulsed drive current control such as PWM or PCM or the like. For example, in PWM controlled systems the duty factors are increased or reduced, if required, in order to compensate for respective decreases or increases in the drive current during the ON period of the duty cycle, thereby providing a desired time averaged drive current to the one or more light-emitting elements. In another embodiment, in PCM controlled systems the pulse density is increased or decreased in order to compensate for drive current fluctuations due to drive current ripple.

FIG. 2 illustrates example variations in current supplied by a power converter over time, wherein the variations can be primarily due to ripple. As illustrated the current supplied by the power converter can be repetitive over time periods 300.

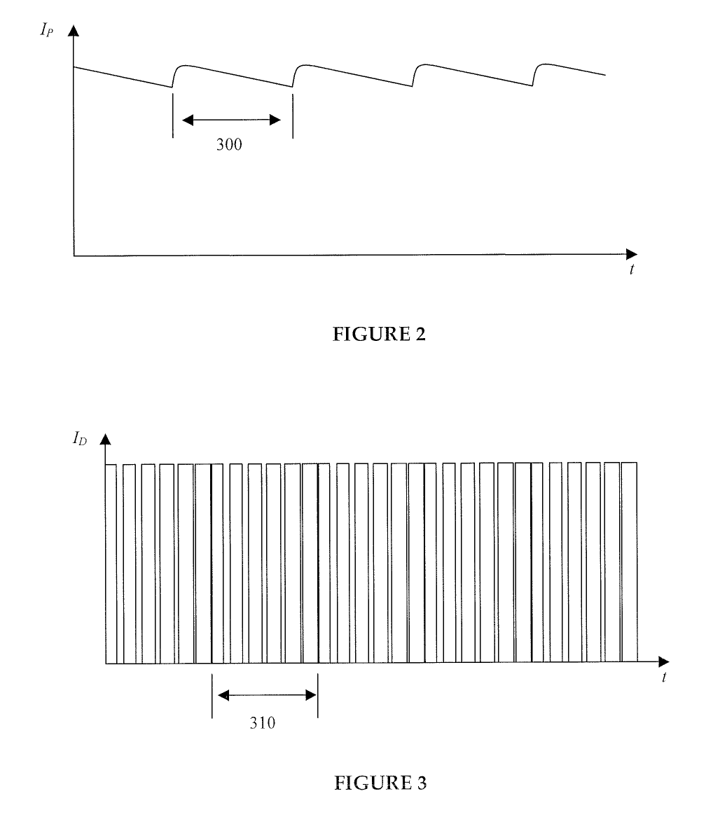

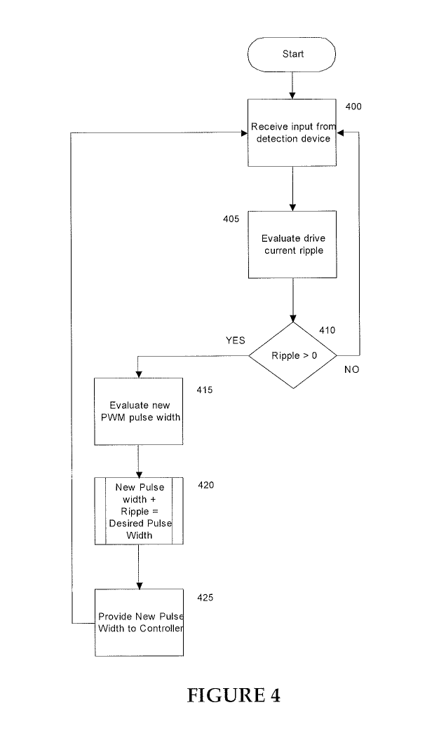

FIG. 3 illustrates ripple compensation through PWM control as can be provided by the ripple compensation apparatus according to an embodiment of the present invention. As illustrated in FIG. 3, the duty factor of the drive current I_{D} supplied to one or more light-emitting elements is progressively increased over the time period of each ripple, which corresponds to time period 310 in this example. This format of ripple compensation can provide a means for maintaining substantially constant brightness or luminous flux output. If for example, control was being performed using PCM, the pulse density of the PCM control signal can be increased over time in order to achieve ripple compensation.

In embodiments of the present invention, wherein analog current control is used to implement ripple compensation, the ripple evaluation module can evaluate a ripple compensation factor, which may include one or more of a compensation waveform, a time-dependent compensation function, and the like, to adjust the amplitude of the drive current for each repetitive time period in order to compensate for ripple within the supplied current. In this manner enabling the compensation of the ripple present within the drive current.

According to embodiments of the present invention, the ripple compensation method can be implemented using a feed-forward and/or a feedback configuration. The complexity of the ripple evaluation module can depend on which configuration is utilized by the ripple evaluation module. Feedback configurations can be adapted to a greater variety of power converters. Feed-forward configurations can usually require some adaptation to match the requirements of a power converter and a particular instance of a feed-forward configuration may only work with desired results for a particular type of power converter.

According to embodiments of the present invention, the magnitude of drive current ripple can substantially differ depending on the load on the power converter. For example, the load on a power converter can be an important consideration when designing a control system for an illumination system. The load on a power converter operatively coupled with an illumination device can vary, in some cases substantially, due to changing current requirements for the light-emitting elements associated with the illumination device when for example changing the illumination colour, chromaticity, dimming or the like. For example, amplitudes of the harmonic content of the drive current can vary with the dynamic range of the power converter under desired operating conditions. Depending on the stability of the power converter, a feed-forward ripple evaluation module design may be more complex than a feedback design, as the range of operating conditions are typically modelled in order to enable the feed-forward operation of the ripple compensation apparatus.

### Feedback Ripple Compensation

In one embodiment of the present invention, feedback ripple compensation can be implemented, for example, by monitoring and integrating the drive current or converter current during ON-periods of the pulse train.

In another embodiment, feedback ripple compensation can be enabled by using an optical sensor which provides an indication of the luminous flux output of one or more light-emitting elements. An optical sensor can be configured in various different formats including, for example, an optical sensor can be configured to provide a signal which is practically proportional to the instant luminous flux output or an optical sensor can be configured to provide an integral of the sensed luminous flux output over a certain amount of time or other configurations as would be known. Depending on the format of an optical sensor, varying configurations of the ripple evaluation module and/or control system may be realised.

In one embodiment of the present invention, drive current, converter current or luminous flux output integration over time can be utilized to determine the integral amount of light emitted since the beginning of an ON-period of a drive current pulse. This collected data can subsequently be used in order to evaluate a ripple compensation factor.

In one embodiment, the ripple evaluation module monitors the integral amount of emitted light since the beginning of an ON-period and compares that integral amount to a desired value. If the desired value has been reached, the ripple evaluation module may turn OFF the one or more light-emitting elements. Additionally the ripple evaluation module or the optical sensor or both, may be reset before the beginning of a new pulse.

In one embodiment of the present invention, the degree to which the duration of an ON-period under non-zero ripple conditions deviates from the duration under no ripple conditions can be determined automatically by the ripple evaluation module by integrating the drive current over time. This collected data can further be used by the ripple compensation module in order to evaluate a ripple compensation factor.

In another embodiment, the duration of OFF-periods can be controlled in a similar way, as to that defined above for the ON-periods.

FIG. 4 illustrates a flow chart for ripple compensation using a feedback configuration according to one embodiment of the present invention. In this example, control of the operation of the one or more light-emitting elements is provided by pulse width modulation. Initially, the ripple compensation module receives input from the one or more detection devices 400, wherein a detection device can be a current sensor, optical sensor or other detection device for sampling operational parameters of the one or more light-emitting elements and/or the power converter. Based on the input received the ripple compensation module determines the drive current ripple 405. At a decision junction 410, if a drive current ripple is present a new PWM pulse width is determined 415, such that the new PWM pulse width plus the ripple is equal to the desired PWM pulse width 420. A PWM control signal based on the new pulse width is provided to the controller 425 in order that the one or more light-emitting elements are appropriately controlled in a manner that compensates for the drive current ripple. As would be readily understood, the desired pulse width is selected such that the time averaged current supplied to the one or more light-emitting elements results in a desired luminous flux output therefrom. The process is subsequently restarted with the reception of new input from the one or more detection devices. If however, drive current ripple is substantially not present, the sequence of steps restarts with the reception of new input from the one or more detection devices.

### Feed-Forward Ripple Compensation

In one embodiment of the present invention, feed-forward ripple compensation can be used and can be implemented wherein the time when an OFF-period is initiated by a feed-forward ripple evaluation module is determined without having to sense the drive current or the amount of emitted light. In a respective feed-forward configuration, the drive current pulses can be generated, for example, at an integer multiple of the frequency of the lowest ripple harmonic. The design of a ripple evaluation module with feed-forward ripple compensation may be realized, if for practical purposes the harmonic amplitudes and frequencies don't vary with load switches, or when the operating conditions of the power converter only depend on the instant drive current and when there is a way for the ripple evaluation module to determine the ripple amplitudes, frequencies and phase shift during ON-periods of the drive current signal. This format can require the ripple evaluation module to synchronize the generation of drive current pulses with the phase of the ripple and to compensate, in a predetermined anticipatory fashion, for the ripple of the drive current amplitude and the fluctuations of the drive current that can be caused because of load variations of the power converter or other fluctuations in the power caused by the instant drive current. An adequately configured ripple evaluation module may be able to compensate ripple which depends not only on the instant but also on past drive current conditions, however, in this configuration the ripple evaluation module may be more complex.

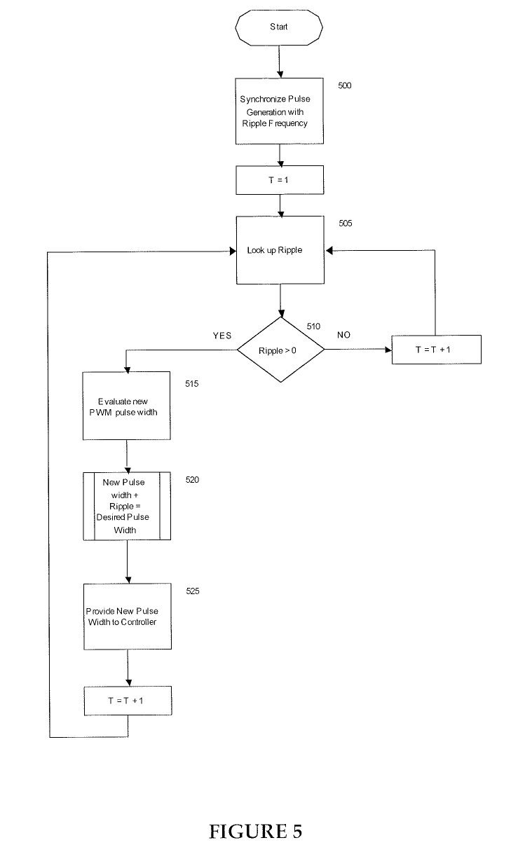

FIG. 5 illustrates a flow chart for ripple compensation using a feed-forward configuration according to one embodiment of the present invention. In this example, control of the operation of the one or more light-emitting elements is provided by pulse width modulation. Initially, the ripple compensation module synchronises the pulse generation with the ripple frequency 500. At a first time point, the ripple compensation module looks up, for example in a look up table, or calculated using an algorithm, the ripple which is expected in the drive current 505. At a decision junction 510, if a drive current ripple is present a new PWM pulse width is determined 515, such that the new PWM pulse width plus the ripple is equal to the desired PWM pulse width 520. A PWM control signal based on the new pulse width is provided to the controller 525 in order that the one or more light-emitting elements are appropriately controlled in a manner that compensates for the drive current ripple. As would be readily understood, the desired pulse width is selected such that the time averaged current supplied to the one or more light-emitting elements results in a desired luminous flux output therefrom. A time step is made to a second time point, wherein the process repeats with the ripple compensation module looking up or calculating the associated ripple in the drive current. If however, drive current ripple is substantially not present, a time step is made to a second time point, wherein the sequence of steps restarts with the ripple compensation module looks up or calculates the ripple in the drive current.

In embodiments of the present invention, wherein analog current control is used to implement ripple compensation, the ripple evaluation module can evaluate a ripple compensation factor to adjust the amplitude of the drive current during each repetitive time period of current ripple, wherein this time period can be defined as illustrated in FIG. 2 and identified as 300. In one embodiment of the present invention, analog current control would follow essentially the same process as defined in the flowcharts illustrated in FIGS. 4 and 5, except that the step of varying the pulse width would be replaced with varying the resistance in the LED drive circuit. The variance of the resistance adjustment can be performed such that it is in synchronization with the power supply ripple to enabling the drive current I_{D}, be maintained at substantially a constant level. For example, the variation of the resistance of the LED drive circuit may be enabled using a metal-oxide semiconductor field-effect transistor (MOSFET) or insulated gate bipolar transistor (IGBT), or other suitable device as would be readily understood by a worker skilled in the art. Furthermore, in this embodiment of the present invention, the current sensors 40 and 110 illustrated in FIG. 1 can be replaced with suitable voltage sensors. In this manner, for example periodic increases in voltage due to ripple can be compensated by suitable increases in resistance thereby enabling the provision of substantially constant drive current.

The ripple compensation can be realized in many different ways which depend on the design of the control system associated with the illumination system, for example, by modifying a respective PWM or PCM pulse generator, modifying the current amplitude via analog current control or bypassing the LEE with switching devices. Respective control systems can be implemented in a purely analog, purely digital or a combined fashion.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

We claim:

1. An apparatus for compensating for ripple in a converter current supplied by a power converter for driving one or more light-emitting elements, the apparatus comprising:
a ripple evaluation module configured to obtain an input indicative of the ripple present in the converter current and evaluate a ripple compensation factor based on said input; and
a controller operatively coupled to said ripple evaluation module and configured to apply said ripple compensation factor to the converter current and thereby provide a drive current for driving the one or more light-emitting elements having reduced ripple.

2. The apparatus of claim 1 wherein a control system comprises said ripple evaluation module and said controller, the control system operatively coupled to the power converter and the one or more light-emitting elements.

3. The apparatus of claim 2 wherein said control system is configured to determine control signals for operation of the one or more light-emitting elements based on said ripple compensation factor and a desired time averaged drive current level.

4. The apparatus of claim 1 wherein said ripple evaluation module is preconfigured with information relating to operational characteristics of one or more different power converters.

5. The apparatus of claim 1 wherein said input is selected from the group comprising: power converter data, drive current data, converter current data, and light output data related to one or more of the one or more light-emitting elements.

6. The apparatus of claim 1 wherein said ripple evaluation module is configured to obtain two or more inputs indicative of said ripple present in the converter current and evaluate said ripple compensation factor based on said two or more inputs.

7. The apparatus according to claim 6, wherein said two or more inputs are selected from the group comprising: power converter data, drive current data, converter current data, and light output data related to one or more of the one or more light-emitting elements.

8. The apparatus of claim 1 wherein said controller applies said ripple compensation factor by modifying a control signal configured in a control signal format selected from the group comprising: analog current control, pulse width modulation control, and pulse code modulation control.

9. The apparatus of claim 1 wherein said ripple evaluation module uses a feed-forward configuration, a feedback configuration, or a combination thereof.

10. A light source comprising:
one or more light-emitting elements;
a power converter for driving said one or more light-emitting elements;
a ripple evaluation module configured to obtain an input indicative of the ripple present in a converter current supplied by said power converter, and evaluate a ripple compensation factor based on said input; and
a controller operatively coupled to said ripple evaluation module and configured to apply said ripple compensation factor to said converter current and thereby provide a drive current for driving said one or more light-emitting elements having reduced ripple.

11. The light source of claim 10 wherein a control system comprises said ripple evaluation module and said controller, the control system operatively coupled to said power converter and said one or more light-emitting elements.

12. The light source of claim 11 wherein said control system is configured to determine control signals for operation of said one or more light-emitting elements based on said ripple compensation factor and a desired time averaged current level.

13. The light source of claim 10 wherein said ripple evaluation module is preconfigured with information relating to operational characteristics of one or more different power converters.

14. The light source of claim 10 wherein said input is selected from the group comprising: power converter data, drive current data, converter current data, and light output data related to one or more of the one or more light-emitting elements.

15. The light source of claim 10 wherein said ripple evaluation module is configured to obtain two or more inputs indicative of said ripple present in the converter current and evaluate said ripple compensation factor based on said two or more inputs.

16. The apparatus according to claim 15, wherein said two or more inputs are selected from the group comprising: power converter data, drive current data, converter current data, and light output data related to one or more of the one or more light-emitting elements.

17. The light source of claim 10 wherein said controller applies said ripple compensation factor by modifying a control signal configured in a control signal format selected from the group comprising: analog current control, pulse width modulation control, and pulse code modulation control.

18. The light source of claim 10 wherein said ripple evaluation module uses a feed-forward configuration, a feedback configuration, or a combination thereof.

19. A method for compensating for ripple in a converter current supplied by a power converter for driving one or more light-emitting elements, the method comprising the steps of:
obtaining an input indicative of the ripple present in the converter current;
evaluating a ripple compensation factor based on said input; and
applying said ripple compensation factor to the converter current and thereby providing a drive current for driving the one or more light-emitting elements having reduced ripple.

20. The method of claim 19 wherein said input is selected from the group comprising: power converter data, drive current data, converter current data, and light output data related to one or more of the one or more light-emitting elements.

21. The method of claim 19 wherein said obtaining step comprises obtaining two or more inputs indicative of said ripple present in the converter current, and said evaluating step comprises evaluating said ripple compensation factor based on said two or more inputs.

22. The method according to claim 21, wherein said two or more inputs are selected from the group comprising: power converter data, drive current data, converter current data, and light output data related to one or more of the one or more light-emitting elements.

23. The method of claim 19 wherein said applying step comprises applying said ripple compensation factor by modifying a control signal configured in a control signal format selected from the group comprising: analog current control, pulse width modulation control, and pulse code modulation control.

24. The method of claim 19 wherein said evaluating step uses a feed-forward configuration, a feedback configuration, or a combination thereof.
